(19) United States
(12) Patent Application Publication
(10) Pub. No.: US 2010/0032927 A1
(43) Pub. Date: Feb. 11, 2010

(54) Convertible cart table

(76) Inventor: Jeffery A. Gordon, Clementon, NJ (US)

Correspondence Address: Hollstein Keating Cattell Johnson & Goldstein P.C.;Willow Ridge Executive Office Park, Suite 301, 750 Rt. 73S., Marlton, NJ, 08053, US

(21) Appl. No.: 12/586,896

(22) Filed: Sep. 29, 2009

Related U.S. Application Data
(63) Continuation-in-part of application No. 12/221,576, filed on Aug. 5, 2008, now abandoned.

(51) Int. Cl. B62B 5/06; B62B 3/02

(52) U.S. Cl. 280/659; 280/651

(57) ABSTRACT

A convertible cart table has a horizontally extending base member with leg members pivotably connected to the underside of the base member. A plurality of wheels are also secured to the underside of the base member. When the invention is to be used as a table, the legs are pivoted down to raise the base member. When the invention is to be used as a cart, the legs are pivoted up to rest substantially parallel to the underside of the base member, so that the base member is lowered to rest on the wheels. A versatile, independent frame element is provided which, when the base member is used as table, is horizontally slideable within dual channel members, to extend the length of the table. When the base member is used as a moveable cart, the frame element is supported perpendicularly to the base member as a handle. The frame element also can be used to provide vertical support for the base member, when the base member is used as a table. When not being used, the frame element is stored within the channel members.

This application claims the benefits of parent application Ser. No. 12/221,576 filed on Aug. 5, 2008.

### BACKGROUND OF THE INVENTION

There presently are a wide variety of hand carts which are convertible to table configurations and tables which, in turn, can be converted to manual carts or dollies. However, no convertible cart table system currently exists which provides a self-contained table whose length can not only easily and quickly be extended for use, advantageously, as a massage, tattoo, or similar type table, but also can be readily converted, using the existing self-contained table components, to a horizontally positioned cart or dolly for the transport of bulky items, large and small.

### SUMMARY OF THE INVENTION

It is thus an object of the present invention to overcome the limitations and disadvantages of prior convertible cart tables and to provide a new, improved, and more versatile cart table. This is accomplished by the subject invention, a convertible cart table which has a horizontally extending base member with leg members pivotably connected to the underside of the base member. A plurality of wheels are also secured to the underside of the base member. When the invention is to be used as a table, the legs are pivoted down to raise the base member. When the invention is to be used as a cart, the legs are pivoted up to rest substantially parallel to the underside of the base member, so that the base member is lowered to rest on the wheels. A versatile, independent frame element is provided which, when the base member is used as table, is horizontally slideable within dual channel members, to extend the length of the table. When the base member is used as a moveable cart, the frame element is supported perpendicularly to the base member as a handle. The frame element also can be used to provide vertical support for the base member, when the base member is used as a table. When not being used, the frame element is stored within the channel members.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the cart table of the present invention in its table configuration, showing the frame element as it is to be used with the base member.

FIG. 2 is an isometric view of the cart table of the present invention in its table configuration, showing the frame element secured to the base member.

FIG. 3 is an isometric view of the cart table of the present invention with frame element in a vertical, upright position.

FIG. 4 is an isometric top view of the cart table of the present invention in its cart configuration.

FIG. 5 is an isometric bottom view of the cart table of the present invention in its cart configuration.

FIG. 6 is an isometric top view of a second embodiment of the cart table of the present invention in its table configuration and the anticipated use of its frame element.

FIG. 7 is an isometric top view of the second embodiment of the cart table of the present invention in its table configuration with its frame element in place.

FIG. 8 is an isometric top view of the second embodiment of the cart table of the present invention in its table configuration with its frame element further retracted into the base member of the invention.

FIG. 9 is an isometric top view of the second embodiment of the cart table of the present invention in its table configuration showing an alternate vertical use of the frame element.

FIG. 10 is an isometric top view of the second embodiment of the cart table of the present invention in its cart configuration.

FIG. 11 is an isometric bottom view of the second embodiment of the cart table of the present invention in its cart configuration.

### DETAILED DESCRIPTION OF THE INVENTION

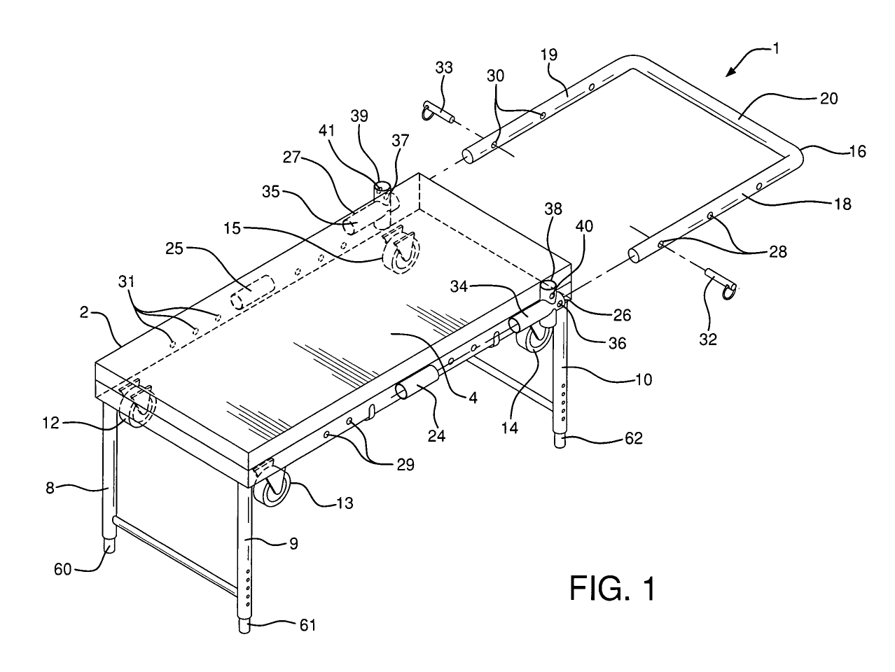

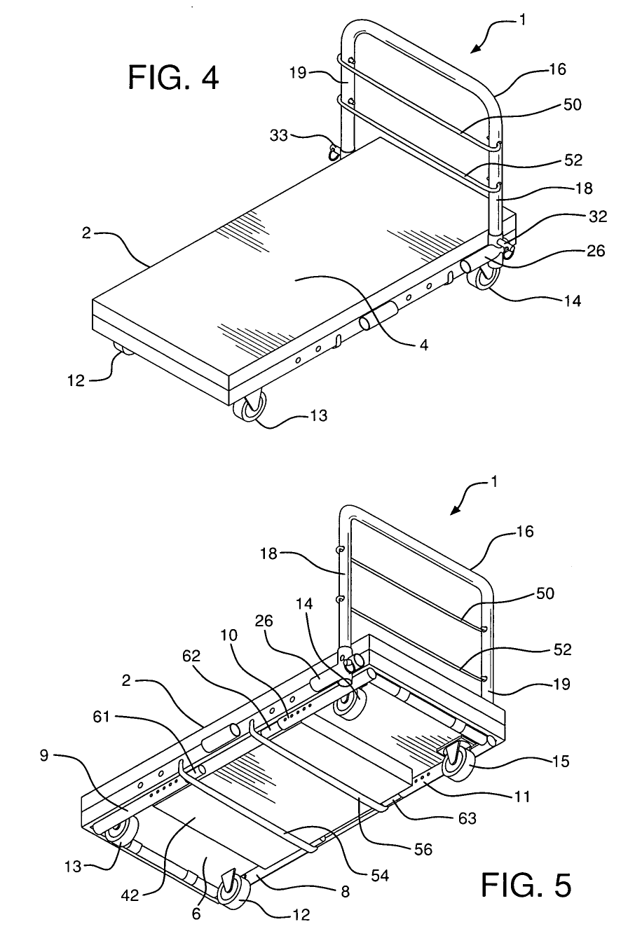

Convertible cart table 1 comprises horizontally extending base member 2 with top surface 4 and undersurface 6. Leg members 8-11 extend downwardly from under surface 6 of base member 2 when the base member is in a raised horizontal position to be used as a table, as shown in FIGS. 1-3. Leg members 8-11 are pivotably mounted between a table configuration, in which base member 2 is in a raised horizontal position and the leg members extend perpendicularly from the base member, to a pivotable position wherein the leg members reside parallel to the undersurface 6 of the base member. In this latter position, base member 2 is lowered to a horizontal position which is parallel to the raised horizontal table position. Base member 2 can then be used as the load bearing component of a cart or dolly, resting on wheels 12-15, as shown in FIGS. 4 and 5. Top surface 4 of base member 2 is used for supporting boxes, equipment, and other items. Front wheels 12 and 13 comprise straight caster type wheels for moving forward and backward, and wheels 14 and 15 comprise swivel type caster wheels, more conducive to maneuvering.

U-shaped frame element 16 is an independent component, separate and completely removeable from cart table 1. Frame element 16 comprises lateral support beams 18 and 19 and cross beam 20. When base member 2 is configured to be used as a basic table, frame extension 16 can be stored by being slideably mounted alongside the base member, within side mounted storage cylinders 24 and 25 and side mounted right angled brackets 26 and 27, as best shown in FIG. 1. Brackets 26 and 27 comprise horizontal tubular members 34 and 35 with holes 36 and 37, and vertical tubular members 38 and 39 with holes 40 and 41. Tubular members 34 and 38, and 37 and 39 are substantially perpendicular to each other. Brackets 26 and 27 are configured to support frame element 16 in angles of 90° and 180° in relation to base member 2. Support beam 18 of frame extension 16 has side holes 28 therethrough which are configured to be aligned with one or more corresponding holes 29 on the side of base member 2. Support beam 19 of cross beam 20 has side holes 30 therethrough which are configured to be aligned with one or more corresponding holes 31 on the other side of base member 2. Cotter pins 32 and 33 extend through holes 28 and 30 in support beams 18 and 19 to lock frame element 16 in position adjacent to base member 2, through holes 29 and 31, or to extend the horizontal length of the base member, as described hereinafter.

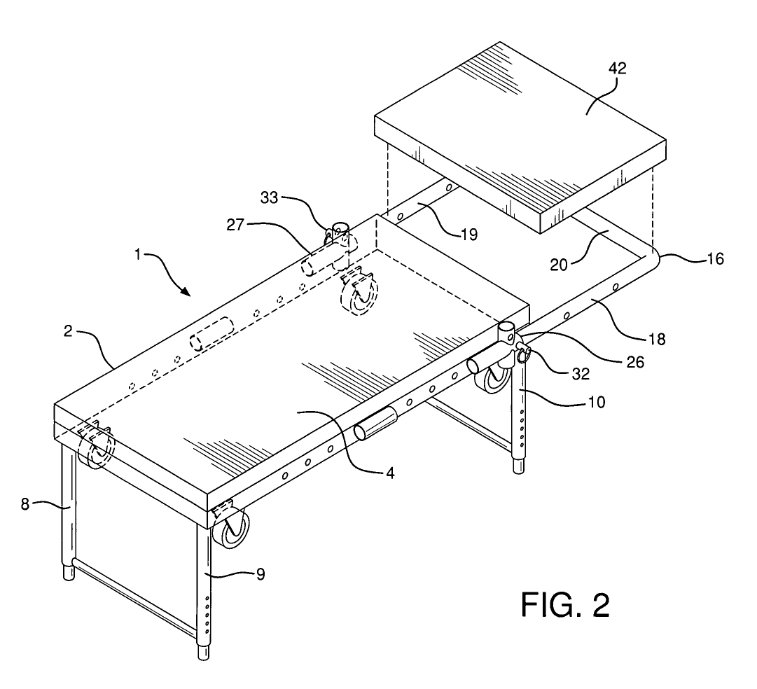

In fact, the horizontal length of base member 2 can be extended by sliding frame element 16 forwardly out of storage cylinders 24 and 25. The ends of support beams 18 and 19 of frame element 16 remain in brackets 26 and 27 and are locked by cotter pins 32 and 33, through holes 36 and 37 in the brackets, such that the frame extension element extends outwardly from the end of the base member, as best shown in FIG. 2. Extender component 42 is configured to be placed within frame element 16.

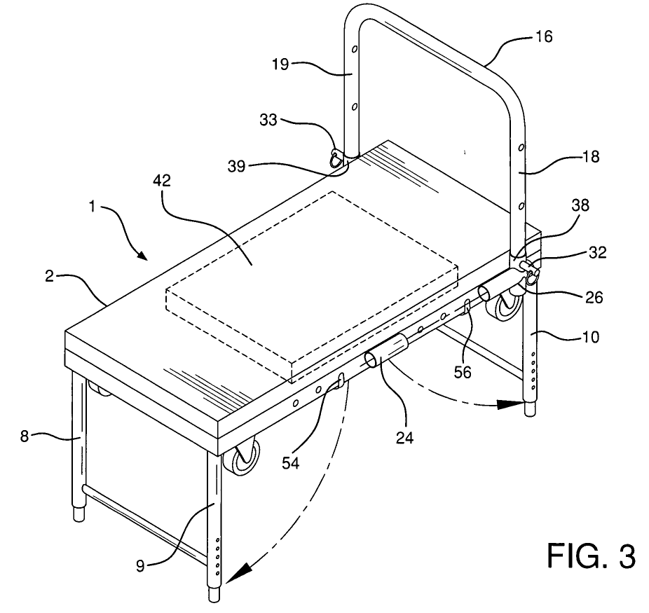

When base member 2 is to be used as a cart, legs 8-11 are pivoted up to their positions along undersurface 6 of the base member, as shown in FIGS. 3 and 5. Cotter pins 32 and 33 are removed from holes 28 and 30 of support beams 18 and 19 and holes 36 and 37 of brackets 26 and 27. Frame element 16 is then slid out of storage cylinders 24 and 25 and brackets 26 and 27 and repositioned substantially perpendicular to base member 2, by insertion into vertical tubular members 38 and 39 of brackets 26 and 27, also as shown in FIGS. 3-5. Cotter pins 32 and 33 or equivalent locking devices are inserted into holes 40 and 41 of tubular members 38 and 39 of brackets 26 and 27, and then into holes 28 and 30 of support beams 18 and 19 to lock frame element 16 in position perpendicular to the base member. In this configuration, frame element 16 becomes a handle for pushing or pulling base member 2, as it travels along on its wheels 12-15.

Bungee chords 50 and 52 are provided to extend between support beams 18 and 19, when base member 2 is used as a cart, to prevent items located on top surface 4 of the base member from falling between the support beams. Additional bungee chords 54 and 56 are designed to be attached over under surface 6 of base member 2, to store extender component 42 under base member 2 when this component is not being used.

When frame element 16 is in the position shown in FIG. 3, it will also serve as an upright vertical support, enhancing the use of cart table 1 when it is used as a table.

Legs 8-11 are height adjustable. Tubular elements 60-63 are slideably mounted within legs 8-11 and the height of the legs can be adjusted by means of a spring-loaded pin system, known in the art, located within each of the legs.

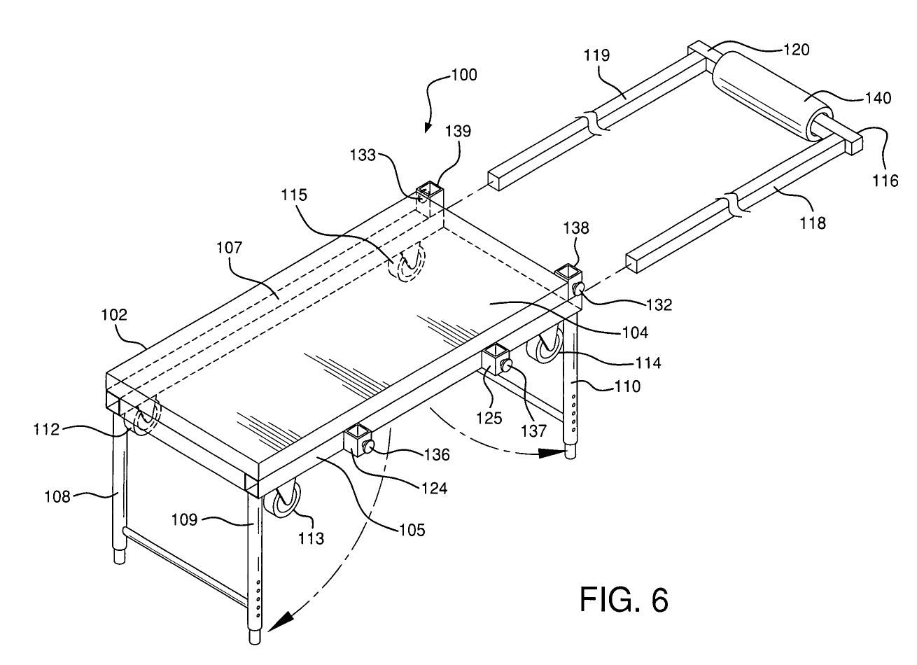

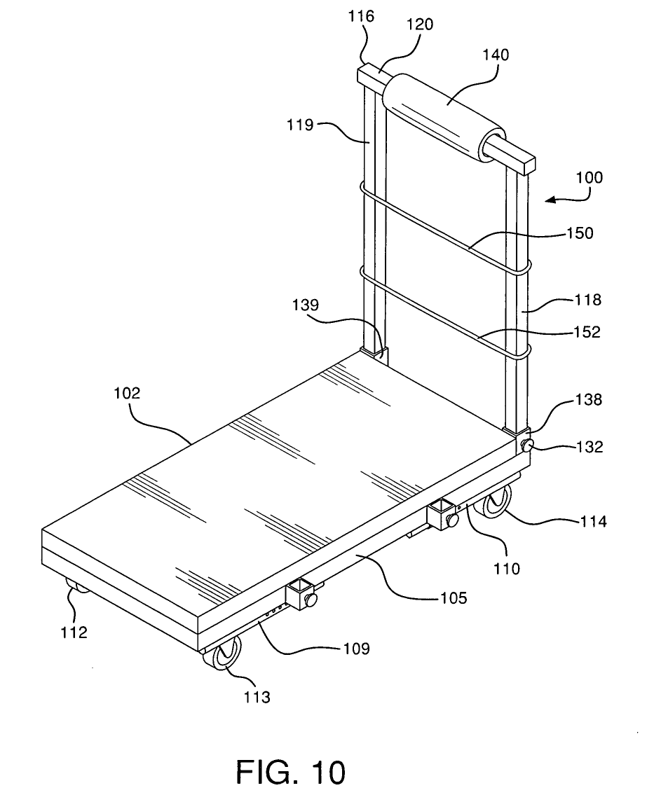

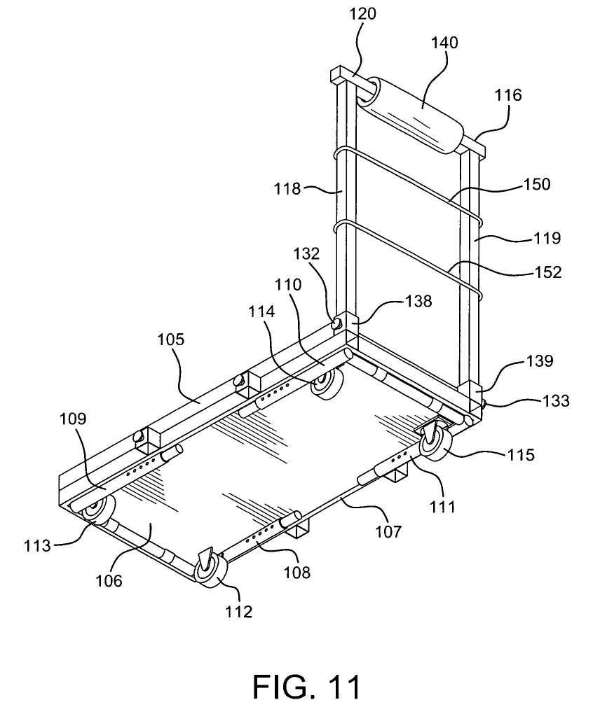

In a second embodiment, convertible cart table 100 comprises horizontally extending base member 102 with top surface 104 and undersurface 106. Leg members 108-111 extend downwardly from under surface 106 of base member 102 when the base member is in a raised horizontal position to be used as a table, as shown in FIGS. 6-9. As described above with reference to FIGS. 1-3, leg members 108-111 are pivotably mounted between a table configuration, in which base member 102 is in a raised horizontal position and the leg members extend perpendicularly from the base member, to a pivotable position wherein the leg members reside parallel to the undersurface 106 of the base member. In this latter position, base member 102 is lowered to a horizontal position which is parallel to the raised horizontal table position. Base member 102 can then be used as the load bearing component of a cart or dolly, resting on wheels 112-115, as shown in FIGS. 10 and 11. In this configuration, top surface 104 of base member 102 is used for supporting boxes, equipment, and other items. Front wheels 112 and 113 comprise straight caster type wheels for moving forward and backward, and wheels 114 and 115 comprise swivel type caster wheels, more conducive to maneuvering.

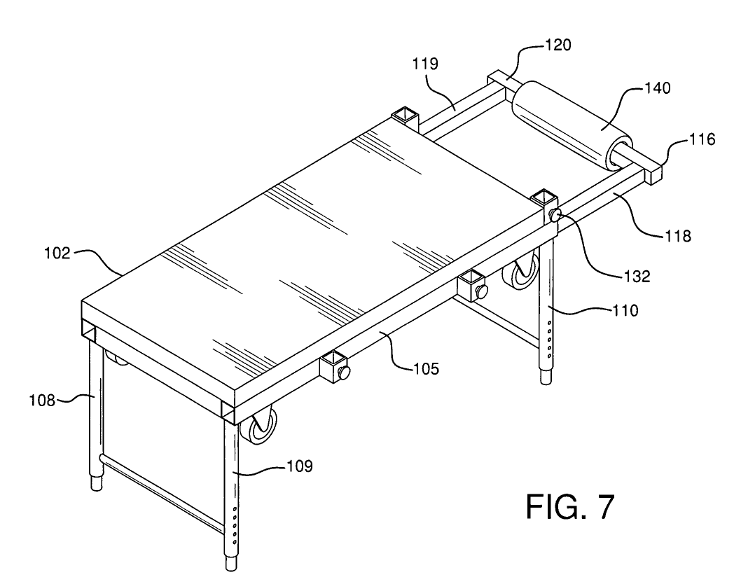

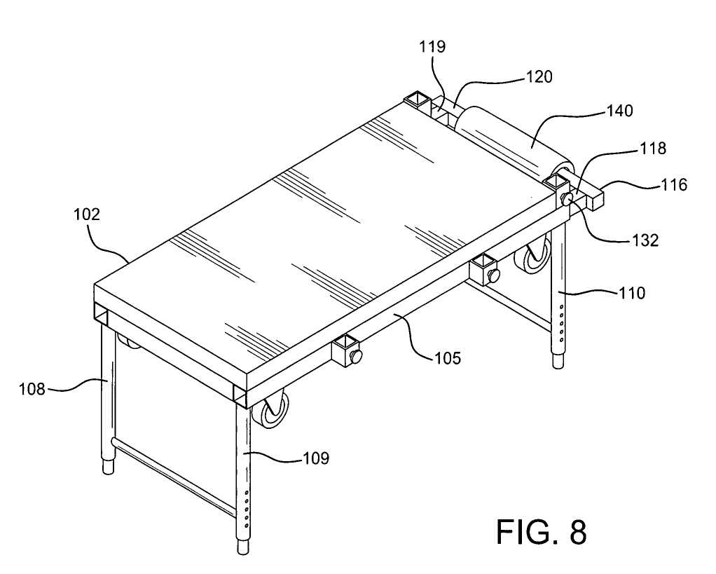

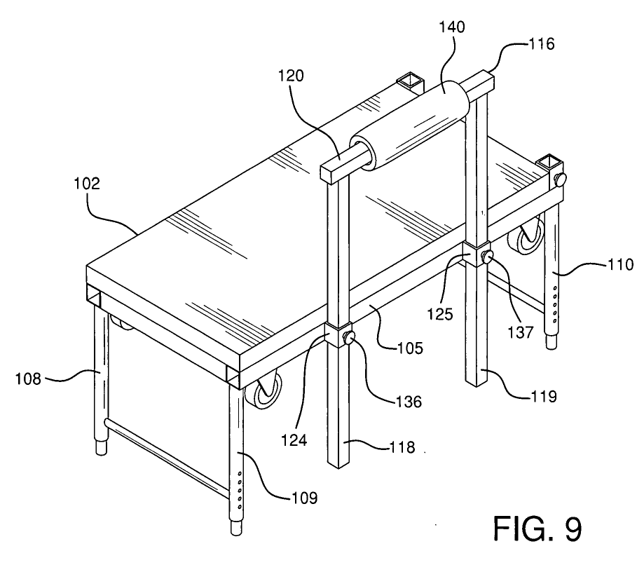

U-shaped frame element 116 is an independent component, separate and completely removeable from cart table 100. It comprises lateral support beams 118 and 119 and cross beam 120. Frame element 116 can be stored within channel members 105 and 107 as seen in FIG. 8. In this configuration, with leg members 108-111 pivoted down, cart table 100 can be used as a table, frame element 116 being held in place by threaded locking connectors 132 and 133. Frame element 116 can also be slid outward and secured by locking connectors 132 and 133 in the position depicted in FIG. 7, to increase the useable horizontal length of base member 102 of cart table 100. Finally, frame 116 can be completely withdrawn from base member 102, as seen in FIG. 6, and secured to channel member 105 by insertion into brackets 124 and 125, and locked in place therein by locking connectors 136 and 137. See FIG. 9. Foam pad 140, encircling cross beam 120, is provided for use as a head support for a prone individual when frame element 116 is used as shown in FIGS. 7 and 8, or as an upper body or head support when the frame element is used as shown in FIG. 9.

When base member 102 is to be used as a cart, legs 108-111 are pivoted up to their positions along undersurface 106 of the base member, as shown in FIGS. 10 and 11, and frame element 116 is completely removed and separated from base member 102. Frame element 116 is then inserted into upstanding support brackets 138 and 139, such that the frame element is perpendicular to base member 102. See FIGS. 10 and 11. Frame element 116 is then locked in this position by locking connectors 132 and 133 and functions as a cart handle, with padded handhold 140. In this configuration, cart table 100 is used as a cart, moveable on wheels 112 and 115. Bungee cords 150 and 152 are provided to extend between support beams 118 and 119, to prevent items located on base member 102 from falling between the support beams.

Convertible tables 1 and 100 are readily adaptable for a number of purposes, but it has particular use as a massage or tattoo table. The top of base members 2 and 102 can comprise foam with vinyl covering for the comfort of the user. A protective canvas cover can be provided for installation over the padded base member, when the invention is to be used in its travel mode as a cart.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A convertible cart table comprising:
a base member having external channel members;
a plurality of wheels secured to the base member;
leg means connected to the base member for supporting the base member, said leg means being interchangeably convertible into two positions, such that in the first position, the leg means support the base member as a table in a raised horizontal configuration and in the second position the wheels support the base member as a cart in a lowered horizontal configuration, parallel to the raised horizontal configuration; and
frame means:
for increasing the horizontal length of the base member when said base member is used as a table, the frame means being positioned within the channel members during said use as a table;
for providing an upstanding vertical support secured to one of the channel members when said base member is used as a table; and
for moving the base member on the wheels when said base member is used as a cart, said frame means being an independent, disconnected and completely separate component from the base member unless otherwise positioned within or secured to the channel members, or when moving the base member when said base member is used as a cart.

2. The cart table as in claim 1 wherein the leg means comprises four leg members pivotably mounted to the base member.

3. The cart table as in claim 1 wherein the frame means comprises a removeable frame element.

4. The cart table as in claim 3 further comprising connection means for securing the frame element to one of the channel members.

5. The cart table as in claim 4 wherein the frame element is configured to slide horizontally within the channel members to increase the length of the base member and to be slid into and secured to the connection means for providing said upstanding vertical support, when the base member is used as a table.

6. The cart table as in claim 3 further comprising upstanding receptacle means for supporting the frame element as a handle in a position substantially perpendicular to the base member for moving the base member when said base member is used as a cart.

7. The cart table as in claim 3 wherein the frame element is configured to be stored within the channel members.

8. The cart table as in claim 3 further comprising means for locking the frame element to the base member when said frame element is used to increase the horizontal length of the base member.

9. The cart table as in claim 3 further comprising means for locking the frame element to the base member when said frame element is used as a cart.

10. The cart table as in claim 3 wherein the frame element is of U-shaped configuration.

11. A convertible cart table comprising:
a base member with a horizontal top surface and external channel members;
a plurality of wheels secured to the base member;
a plurality of legs pivotably attached to the base member, the legs being interchangeably convertible between a substantially vertical position and a substantially horizontal position in relation to the base member, whereby when the legs are in the vertical position, they support the base member as a table in a raised horizontal configuration, and when the legs are in the horizontal configuration, the wheels support the base member as a cart in a lowered horizontal configuration, parallel to the raised horizontal configuration;
a frame element comprising an independent component, disconnected and completely separate from the base member;
connection means for securing the frame element to one of the channel members; and
upstanding receptacle means for supporting the frame element, whereby the frame element is interchangeably convertible from a position within the channel members to increase the horizontal length of the base member, to a vertical position wherein said frame element is secured to the connection means for providing upstanding vertical support to the base member, to a position within the support means for moving the base member on said wheels.

12. The cart table as in claim 11 wherein the legs are pivotably mounted to the base member.

13. The cart table as in claim 11 wherein the frame element is configured to slide horizontally within the channel members to increase the length of the base member.

14. The cart table as in claim 11 wherein the receptacle means supports the frame element as a handle in a position perpendicular to the base member.

15. The cart table as in claim 11 wherein the frame element is configured to be stored within the channel members.

16. The cart table as in claim 11 further comprising means for locking the frame element to the base member when said frame element is used to increase the horizontal length of the base member.

17. The cart table as in claim 11 further comprising means for locking the frame element to the base member when said frame element is used as a cart.

18. The cart table as in claim 11 wherein the frame element is of U-shaped configuration.
